(19) United States
(12) Patent Application Publication
(10) Pub. No.: US 2005/0097685 A1
(43) Pub. Date: May 12, 2005

(54) Continuous dyeing of fabrics comprising cellulosic fibers

(75) Inventors: Bertram Seuthe, Bielefeld (DE); Franz Peter Tolksdorf, Heppenheim (DE); Kurt Van Wersch, Wegberg (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 10/968,596

(22) Filed: Oct. 19, 2004

(30) Foreign Application Priority Data
Oct. 21, 2003 (DE) DE 103 49 435.9

(51) Int. Cl. G03C 5/18; D06P 3/60

(52) U.S. Cl. 8/518

(57) ABSTRACT

A process for producing a reproducible ring dyeing with sulfur dyes on fabrics consisting of cellulosic fibers and blend fabrics containing cellulosic fibers comprises the application of the sulfur dye vat to the fabric being followed by a step in which the sulfur vat dye is fixed and incipiently oxidized at a temperature of 80 to 160° C. and preferably at a temperature of 120 to 130° C. and a moisture content of 5% to 50%, and preferably 20% to 35%.

The present invention relates to a process for continuous dyeing of fabrics comprising cellulosic fibers with sulfur dyes on a hot flue dryer.

Conventional processes for continuous dyeing with sulfur dyes, sulfur vat dyes and water-soluble sulfur dyes are operated as the pad-steam process, or else, in the case of sulfur vat dyes and water-soluble sulfur dyes, as the pad-dry process or alternatively as the pad-dry-pad-steam process.

In the pad-steam process, the sulfur dye is applied in the reduced state to the fabric from a pad-mangle trough or comparable application means and subsequently squeezed off under a defined pressure. Dye diffusion into the fiber takes place in a subsequent steaming operation under saturated steam conditions, i.e., at an atmospheric humidity of 100% and about 102° C. This is followed by rinsing and oxidation of the dye. The fiber obtained is through dyed.

In the pad-dry process, the sulfur dye is likewise in its reduced state when it is applied from a pad-mangle trough or comparable application means to the fabric and subsequently squeezed off under a defined pressure. The fabric thus treated passes through a pre-dryer having a downstream hot flue (forced-air dryer) at about 150° C. The dye is partially oxidized in this hot flue. This is followed by rinsing and oxidation. The level of fixation achieved is insufficient.

In the pad-dry-pad-steam process, the sulfur dye is in a dispersed or dissolved state when applied to the fabric from a pad-mangle trough or comparable application means and subsequently squeezed off under a defined pressure. In contradistinction to the pad-steam operation, the dyed fabric is initially dried and it is only then that dye diffusion into the fiber is effected by overpadding, i.e., by impregnating in a downstream chemical pad with a subsequent steaming operation under saturated steam conditions at about 102° C. This is followed by rinsing and oxidation, which converts the sulfur dye back into its water-insoluble form. The fiber obtained is fully through-dyed.

These processes provide either good through-dyeing of the fiber or a very insufficient fixation of the dye on the fiber surface which lead to problems with the reproducibility of the dyeings.

But the fashion is now for articles which exhibit a very pronounced wash-down effect or modifications achieved utilizing this effect. This effect is obtainable via a so-called ring dyeing, i.e., the fiber is only dyed at the surface, while the interior of the fiber, the core, remains undyed, or else retains its original coloration on using a fiber through dyed with other dyes, as with reactive dyes for example. Ring dyeing makes it possible to provide cellulosic fibers and blend fabrics containing cellulosic fibers with a high-contrast appearance in particular washing and/or bleaching processes by achieving a removing or lightening of the initial ring dyeing.

There is accordingly a demand for a simple process for producing reproducible ring dyeings with sulfur dyes on fabrics consisting of cellulosic fibers and blend fabrics containing cellulosic fibers.

The present invention, then, provides such a process.

The invention provides a process for producing a reproducible ring dyeing with sulfur dyes on fabrics consisting of cellulosic fibers and blend fabrics containing cellulosic fibers, which comprises the application of the sulfur dye vat to the fabric being followed by a step in which the sulfur vat dye is fixed and incipiently oxidized at a temperature of 80 to 160° C. and preferably at a temperature of 120 to 130° C. and a moisture content of 5% to 50%, and preferably 20% to 35%.

The process of the present invention requires defined temperature and moisture conditions, and they can be achieved with the aid of a specific hot flue apparatus. Hot flue dryers are described for example in EP 0 797 698 for reactive dyeings.

The process of the present invention thus ideally provides a homogeneous product which can be modified by removing the dye superficially adhering to the dyed fiber ring and baring the dyed or undyed core. The core can be pre-dyed for example with reactive dyes, with vat dyes, with indigo, with sulfur dyes, direct dyes, pigment dyes or with Naphtol dyes.

The procedure is in detail as follows:

The sulfur dye is in a reduced state (i.e., rendered water-soluble by chemical reduction) when it is applied cold or at temperatures of up to 95° C. to the fabric from a pad-mangle trough or similar application means and subsequently squeezed off under defined pressure. Reducing agents used are commercially available reducing agents, for example sodium sulfide or hydrosulfite in combination with sodium carbonate or aqueous sodium hydroxide solution, glucose alone or in admixture with hydrosulfite with sodium carbonate or aqueous sodium hydroxide solution, sodium hydrogensulfide in an alkaline medium. This is followed by drying of the fabric on a hot flue dryer in the moisture range of 5-50% at drying temperatures in the range of 80-160° C. within 0.5-20 minutes, followed by an oxidation and the usual wash to remove excess dye.

Useful dyes for this process include all commercially available sulfur dyes, preferably pre-reduced or incipiently reduced liquid sulfur brands, for example Cassulfon® or Cassulfon-C® brands, and also powder brands of the type Hydron®, Stabilisol®, and also Hydron® liquid brands, as well as water-soluble sulfur dyes of the Hydrosol® type. The amounts used are preferably in the range from 5 to 400 g/l, and more preferably in the range from 50 to 250 g/l.

The process of the present invention can be carried out with and without wetting agents, sequestering or dispersing agent, preferably it is conducted in the presence of an anionic wetting agent.

The fabrics dyed by the process of the present invention, consisting of cellulosic fibers or containing cellulosic fibers, can be subjected to further treating steps to achieve certain effects. This can apply not only to the dyed fabric in open width, in rope form (jet treatment) but also the made-up state.

The wash-down effect of fabrics dyed according to the present invention, which consist of cellulosic fibers or contain cellulosic fibers, can be visualized for example by removing the outer ring of the yarn through washing or some other mechanical and or chemical stressor, for example bleaching, enzyme washing, stone washing or combinations thereof, and the pre-dyed or undyed core coming to light as a result.

The present invention also provides textile articles comprising fabrics consisting of cellulosic fibers and blend fabrics containing cellulosic fibers that have been obtained by the process according to the present invention. Such textile articles are for example cellulose fabrics which have or have not been made up, but in particular garments such as pants, skirts, shirts, jackets, etc. or other textile articles.

The examples which follow illustrate the invention.

### EXAMPLE 1

Overdyeing of sized denim fabrics dyed in the warp yarn

Dyeing was carried out on a Thermex hot flue from Monforts:

1) dyeing recipe:
200 g/l Cassulfon Black SR
5 g/l Stabilisal S
5 g/l Sulfhydrat F 150%
1 ml/l 38° Be caustic soda
4 ml/l anionic wetting agent

2) impregnating and squeezing off in pad-mangle:
temperature of dyeing liquor: 20° C.
wet pickup: 52%
speed: 12 m/min

3) pre-dryer (IR shaft)
cold

4) Thermex hot flue
speed: 12 m/min
ambient moisture: 35%
temperature: 130° C.

5) washing, oxidizing, washing
The sulfur dyeing was washed and oxidized on a commercially available open-width washer at pH 4-4.5 and 70° C.

### EXAMPLE 2

Overdying of pre-bleached cotton fabric

1) dyeing recipe:
200 g/l Cassulfon Blue BRH
5 g/l Stabilisal S
5 g/l Sulfhydrat F 150%
1 ml/l 38° Be caustic soda
4 ml/l anionic wetting agent

2) impregnating and squeezing off in pad-mangle:
temperature of dyeing liquor: 20° C.
wet pickup: 52%
speed: 12 m/min

3) pre-dryer (IR shaft)
cold

4) Thermex hot flue
speed: 12 m/min
ambient moisture: 35%
temperature: 130° C.

5) washing, oxidizing, washing
The sulfur dyeing was washed and oxidized on a commercially available open-width washer at pH 4-4.5 and 70° C.

1. A process for producing a reproducible ring dyeing with sulfur dyes on fabrics consisting of cellulosic fibers and blend fabrics containing cellulosic fibers, which comprises the application of the sulfur dye vat to the fabric being followed by a step in which the sulfur vat dye is fixed and incipiently oxidized at a temperature of 80 to 160° C. and preferably at a temperature of 120 to 130° C. and a moisture content of 5% to 50%, and preferably 20% to 35%.

2. The process according to claim 1 that utilizes not only an undyed cellulosic fiber but also a cellulosic fiber which has been pre-dyed with reactive dyes, with vat dyes, with indigo, with sulfur dyes, direct dyes, pigment dyes or with Naphtol dyes.

3. The process according to claim 1 or 2 wherein the sulfur dye used comprises pre-reduced or incipiently reduced liquid sulfur brands, for example Cassulfon® or Cassulfon-C® brands, and also powder brands of the type Hydron®, Stabilisol®, and also Hydron® liquid brands, as well as water-soluble sulfur dyes of the Hydrosol® type.

4. The process according to one or more of claims 1 to 3 conducted with or without wetting agents, sequestrants and or dispersants.

5. Fabric comprising cellulosic fiber and blend fabrics containing cellulosic fibers obtained by the process of the present invention.
